(19) United States
(12) Patent Application Publication
(10) Pub. No.: US 2022/0405688 A1
(43) Pub. Date: Dec. 22, 2022

(54) COOPERATIVE DECISION MAKING IN A SOCIAL NETWORK

(71) Applicant: AMI Holdings Limited, Hamilton (BM)

(72) Inventors: Ronen Benchetrit, London (GB); Tariq Masud Shaukat, Austin, TX (US)

(21) Appl. No.: 17/843,492

(22) Filed: Jun. 17, 2022

Related U.S. Application Data
(60) Provisional application No. 63/212,951, filed on Jun. 21, 2021.

(51) Int. Cl. G06Q 10/06; G06Q 50/00

(52) U.S. Cl. CPC G06Q 10/063112; G06Q 50/01

(57) ABSTRACT

Systems, methods, and computer-readable media for cooperative decision making in a social network include identifying a potential match between a first individual and a second individual based on interests of the first individual, receiving, from a first client device associated with the first individual, a request for input regarding the potential match, and, in response to the request, identifying other individuals for providing input to the first individual regarding the potential match, supplying profile information for the second individual to client devices associated with the first individual and the other individuals, enabling network communication between the first individual and the other individuals for providing the input to the first individual regarding the potential match, and receiving a vote to connect the first individual with the second individual from the first client device or at least one of the other client devices.

### CLAIM OF PRIORITY

This application claims priority under 35 U.S.C. 119(e) to U.S. patent application Ser. No. 63/212,951, filed on Jun. 21, 2021, the contents of which are hereby incorporated by reference.

### TECHNICAL FIELD

This disclosure relates generally to social media dating applications deployed in computer networks.

### BACKGROUND

Social media dating applications propose matches between individuals. Once a proposed match is accepted, matched individuals may communicate with one another electronically using the dating application.

### DESCRIPTION OF DRAWINGS

FIG. 1 illustrates a system.

FIG. 2 illustrates processing operations.

FIGS. 3A and 3B illustrate user interfaces.

FIGS. 4 and 5 illustrate user interfaces.

FIGS. 6A through 6D illustrate a system and user interfaces.

Like reference symbols in the various drawings indicate like elements.

### DETAILED DESCRIPTION

The technology described here facilitates cooperative decision making in a social network in order to, for example, assist a user of the social network in determining whether to connect with other individuals. In some implementations, a user of the social network is served profiles of one or more other users who have been identified by a matching engine as potential matches for the user. The user (sometimes referred to as the “requesting user”) can request input on one or more of the potential matches from another user or group of users (sometimes referred to as the “reviewing users”). In response to the request, a selection engine can identify the reviewing users for providing input, and can send the profile of the potential matches to the reviewing users for review. The selection engine can also enable network communications between the requesting user and the reviewing users to allow each of the users to react to or discuss the potential matches. Based on the input from reviewing users, the requesting user can decide whether to connect with one or more of the potential matches. In some implementations, the reviewing users can serve as proxies for the requesting user and can make decisions in the social network on behalf of the requesting user.

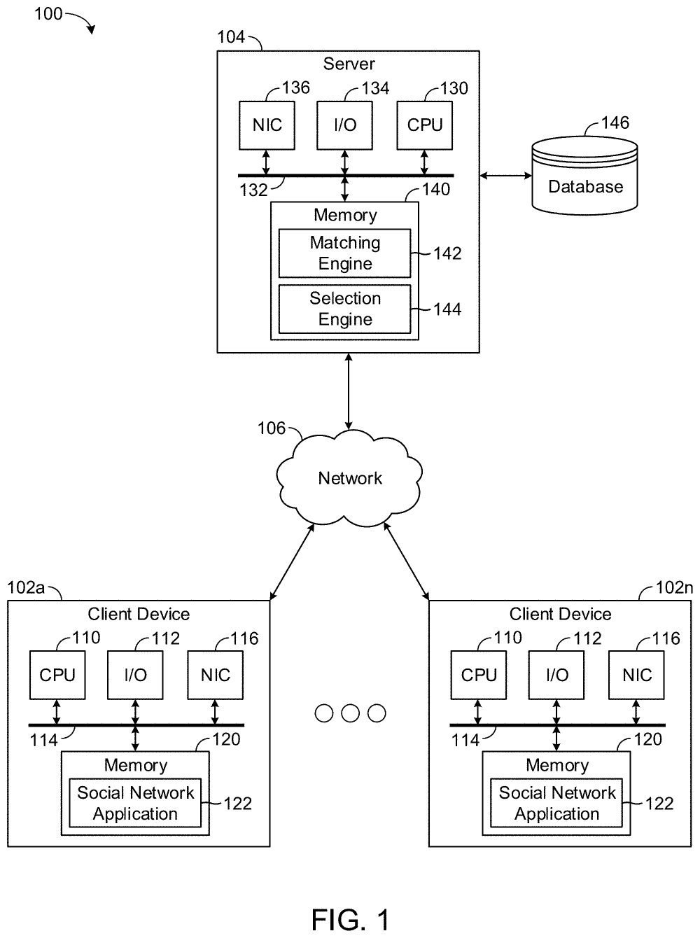

FIG. 1 illustrates a system 100 for cooperative decision making in a social network. The system 100 includes a plurality of client devices 102a through 102n in communication with a server 104 via a network 106, which may be a wired or wireless network or any combination thereof. Each client device 102a through 102n (referred to collectively as client devices 102) includes a processor (e.g., central processing unit) 110 in communication with input/output devices 112 via a bus 114. The input/output devices 112 can include a touch display, keyboard, mouse, and the like. A network interface circuit 116 is also connected to the bus 114 to provide wired and/or wireless connectivity to the network 106. A memory or other storage medium 120 is also connected to the bus 114. The memory 120 stores instructions executed by the processor 110. In particular, the memory 120 stores instructions for a social network application 122, such as a dating application, which communicates with server 104 to coordinate introductions between users that have been identified as potential matches (e.g., potentials friends, dating partners, business partners, etc.). In some implementations, each client device 102 is a mobile device (e.g., smartphone, laptop, tablet, wearable device, etc.) executing the social network application 122. Different client devices 102 are operated by different users that subscribe to the same social network application 122.

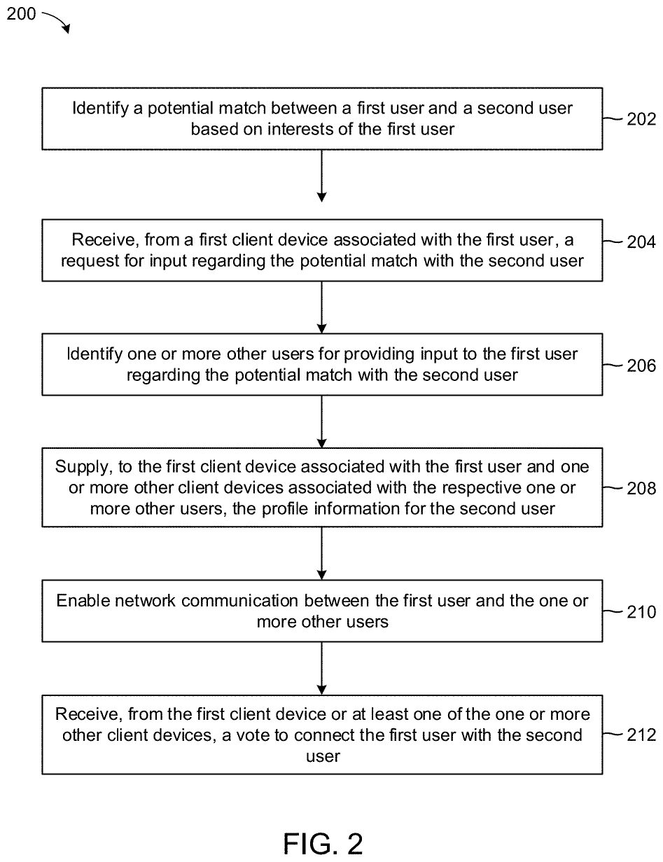

The server 104 includes a processor 130, bus 132, input/output devices 134 and a network interface circuit 136 to provide connectivity to the network 106. A memory 140 is connected to the bus 132. The memory 140 stores a matching engine 142 and a selection engine 144 with instructions executed by the processor 130 to implement operations disclosed in connection with FIGS. 2 through 6. In some implementations, the system 100 includes a database 146 in communication the server 104 that stores information for use by the social network application 122, the matching engine 142, and/or the selection engine 144, such as user profile information, match information, message information, or other information.

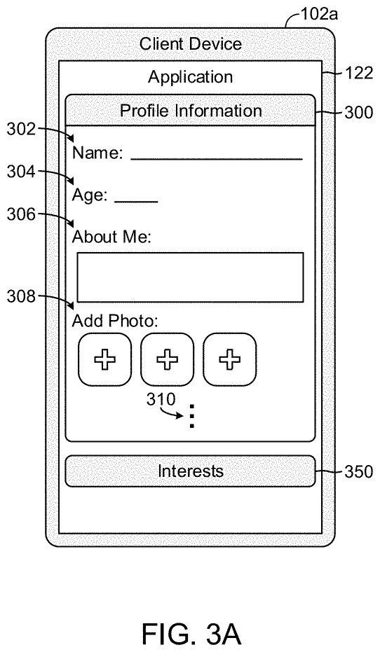

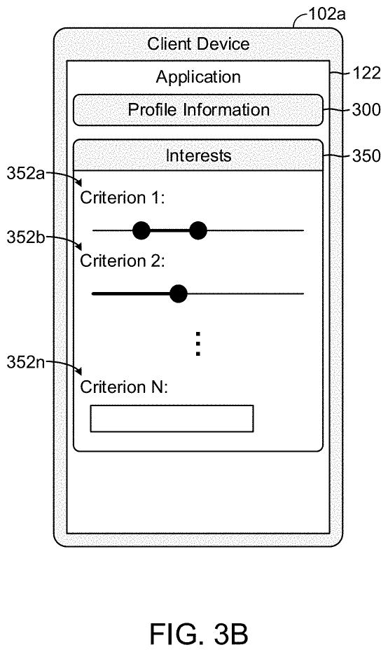

In operation, a user of a client device 102 can create a personal profile to participate in the social network application 122. For example, referring to FIG. 3A, a user can create a personal profile by interacting with a user interface to provide profile information 300, such as their name 302, age 304, biographical text 306, photographs 308, and a range of other fields 310 (e.g., city, links to social media profiles on other networks, etc.) that allow the user to characterize himself or herself. Each user can also specify their interests 350 for use in identifying potential matches. For example, as shown in FIG. 3B, a user can specify their interests 350 by interacting with a user interface to provide various criterion 352a through 352n that the user is looking for in a potential match, such as age, distance, hobbies, commitment disposition, or combinations of them, among others. In some implementations, the system 100 (e.g., the matching engine 142) can identify one or more of the criterion 352a through 352n instead of or in addition to those specified by the user based on, for example, analysis of the user's interactions with the system 100. The system 100 (e.g., the matching engine 142) can use the interests 350 to generate matching criteria for use in identifying potential matches for the user.

Once a profile is complete, a user can begin to view the profiles of other users, while the user's own profile is circulated among the user base. In some implementations, a user receives profiles of other users who have been identified as potential matches based on their interests 350. For example, the matching engine 142 can process the profiles of other users to identify those users who satisfy the interests 350 specified by a user. In some implementations, the matching engine 142 can derive matching criteria from the interests 350, and can use the matching criteria to identify potential matches. The matching engine 142 can then provide the profiles of the potential matches to the user for review. In general, the matching engine 142 can use filters, applied rules, machine learning, or combinations of them, among others, to identify potential matches for a user. For example, the matching engine 142 can generate one or more filters or rules based on the interests of a user, and can apply the filters or rules to profile information for other users to identify potential matches for the user. As another example, the matching engine 142 can include a machine learning model (e.g., a neural network model) trained to identify features from the interests of a user, and the machine learning model can process profile information for other users to identify potential matches for the user.

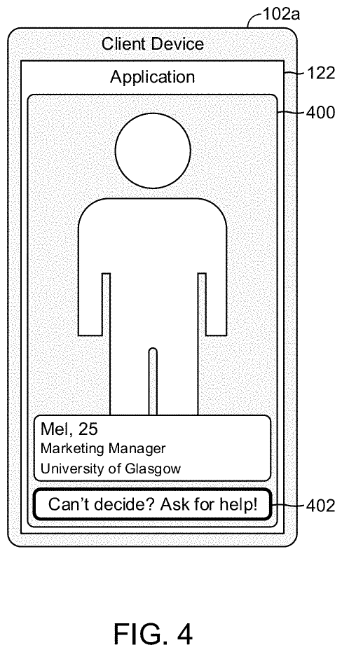

After identifying one or more potential matches for a user, the matching engine 142 can provide the profiles of the potential matches to the user for review. The user is able to explore the information that has been added to each profile. For example, referring to FIG. 4, the application 122 executing on the client device 102 can display a user interface 400 that allows the user to view and explore the information that has been added to a potential match's profile. The user interface 400 can also include a prompt 402 to the user to request input on the profile from one or more other users, as discussed below.

To ascertain a mutual agreement to connect two users together, each profile can be voted on by the viewing user. For example, having viewed the personal profile of another user, the viewing user can vote ‘yes’ if they would like to connect with that specific user, or vote ‘no’ if they are not interested in connecting. In some implementations, a user can vote ‘yes’ by interacting with a first user interface button or swiping (e.g., clicking and dragging the profile using their finger) the profile off the screen in a certain direction (e.g., right), and can vote ‘no’ by interacting with a second user interface button or swiping in another direction (e.g., left). In some implementations, once a user has voted ‘yes’ for a profile of another user, the matching engine 142 can place the profile of the user into the queue of profiles to be viewed by the other user. Through this mechanism the matching engine 142 is able to accelerate the pace with which two users view each other's profiles than would happen in a purely organic system of profile selection.

When two users both mutually vote ‘yes’ upon the other user's profile, a connection (sometimes referred to as a “match”) is established between the two accounts. Once a match is established, the matching engine 142 can supply a notification of the match to either or both of the matched users with a prompt to contact the other matched user. On the other hand, when one user votes ‘yes’ but the other user votes ‘no,’ no further connection is established between the two users, and their profiles are not shown to each other again (or they may be shown again depending on changes within their profile, location, search parameters, or because of time elapsed). In this manner, the matching engine allows the intention of each user within the social network to be communicated.

In some implementations, matched users are directed to a messaging system of the social network to contact the other matched user. Once users are within the messaging system, they can send messages back and forth to one-another. In some implementations, the messaging system displays elements of a user's profile in order to increase recognition of the other user (e.g., name, age, photograph, etc.).

In some implementations, the selection engine 144 (alone or in combination with the matching engine 142) facilitates cooperative review of a profile in order to assist a user with establishing their voting position on a potential match. For example, when a user receives a profile of a potential match for review (or at some other time), the user can request input on the potential match from another user or group of users. In response to the request, the selection engine 144 can identify a reviewing user or group of users for providing input to the requesting user, and can send the profile of the potential match to the reviewing users for review. The selection engine 144 can also enable network communications (e.g., live chat, asynchronous messaging, etc.) between the requesting user and the reviewing users via the social networking platform to allow the users to react to or discuss the potential match.

Based on the input from reviewing user or group of users, the requesting user can decide whether to connect with the potential match and can cast their vote accordingly (e.g., by swiping left or right on the profile). In some implementations, the reviewing user or group of users can vote on the potential match on behalf of the requesting user. The matching engine 142 and/or the selection engine 144 can collect the votes from the reviewing user or group of users and can determine, based on the votes, whether to automatically connect the requesting user and the potential match. By facilitating cooperative review, the system 100 enhances the user experience by, for example, providing the requesting user with relevant feedback from an outside perspective, and enabling reviewing users to interact with the system (e.g., vote) on behalf of the user. These features also improve the ability of dating and social network systems to appropriately connect users.

Turning to FIG. 2, a process 200 for cooperative decision making in a social network is shown. In some implementations, operations of the process 200 are carried out by the social network application 122 executing on each of the client devices 102, the matching engine 142 and/or the selection engine 144 executing on the server 104, or combinations of them.

Initially, the matching engine 142 identifies 202 a potential match between a first user (e.g., a first user associated with a first user account accessed on a first client device 102) and a second user (e.g., a second user associated with a second user account accessed on a second client device 102) based on the interests of one or both of the users. As discussed herein, the matching engine 142 can use filters, applied rules, machine learning, or combinations of them, among others, to identify the potential match between the users.

Once the potential match has been identified, the matching engine 142 can provide, for example, the profile information of the second user to the client device 102 operated by the first user. The application 122 executing on the client device 102 can display the user interface 400 that allows the first user to view and explore the information that has been added to the second user's profile, as shown in FIG. 4.

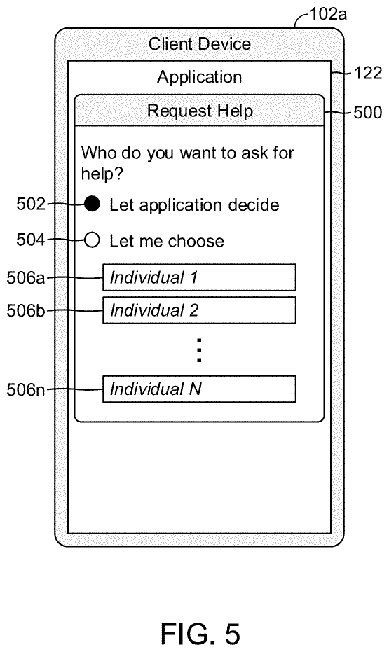

The matching engine 142 receives 204 a request from the first user (the “requesting user”) for input regarding the potential match with the second user. For example, referring to FIG. 4, the user interface 400 can include a prompt 402 to the first user to request input from one or more other users (the “reviewing users”). Upon selection of the prompt 402, the application 122 can present a user interface 500 shown in FIG. 5. The first user can interact with the user interface 500 to specify further information for the request. For example, the first user can select an option 502 to have the system 100 (e.g., the selection engine 144) select the reviewing user or group of users. As another example, the first user can select an option 504 to specify one or more individuals 506a through 506n to serve as reviewing users. In some implementations, the first user can request input from or delegate profile review to one or more reviewing users before the potential match is identified and the profile information is received (e.g., in a separate user interface).

In some implementations, each of the reviewing users (e.g., the individuals 506a through 506n and/or the reviewing users selected by the system) are users of the social network application 122 (or can be invited to join the social network application 122 if they are not users). In this example, the system 100 can identify the reviewing users and coordinate review of the potential match within the application 122, as described below. In some implementations, the reviewing users need not be or become users of the social network application 122 to provide input regarding the potential match. For example, the system 100 can obtain (e.g., from the requesting user or otherwise) contact information, such as a phone number or an email address, for one or more of the reviewing users. The system 100 can then generate and send a webpage URL, an electronic survey, or another form to the reviewing users to allow the reviewing users to provide input without joining the social network. In one implementation, the system 100 generates a unique token (e.g., a unique URL) for each of the reviewing users that is linked to the review of the potential match. The system 100 sends a message (e.g., a SMS message, an email, etc.) to each of the reviewing users with their respective unique token. Upon selection of the unique token, the reviewing user is presented with a graphical user interface (e.g., a dynamic webpage, a specific interface in the application 122 if available on the client device, etc.) that allows the reviewing user to provide input on the potential match or otherwise participate in the collaborative reviewing session, as described herein. In some implementations, the unique token is configured to expire after a predetermined amount of time (e.g., 6 hours, 12 hours, 1 day, etc.) and/or after a triggering event (e.g., completion of the vote on the potential match).

In response to the request, the selection engine 144 identifies 206 one or more reviewing users for providing input to the first user regarding the potential match with the second user. In some implementations, such as when the first user selects the option 504 shown in FIG. 5, the selection engine 144 identifies the reviewing user or group of users based on the individuals 506a through 506n specified in the request. In some implementations, the selection engine 144 randomly selects the reviewing user or group of users from users of the social networking application 122. The selection engine 144 can filter out certain users, such as users who have opted not to receive such requests, users who do not respond to such requests, or users who are otherwise inactive within the social network, before performing such a selection. In some implementations, the reviewing user or group of users need not be online when the first user is online or when the request is received.

In some implementations, the selection engine 144 identifies the reviewing user or group of users based on a relevance of a user to the request. To do so, the selection engine 144 can compare profile information for each of a plurality of users with profile information for the first and/or second users to determine a relevance score for each of the plurality of users. For example, if a user is determined to have similar characteristics (e.g., interests, age, location, etc.) as the first and/or second users based on their respective profiles, then the selection engine 144 can assign the user a higher relevance score relative to a user who does not share the similar characteristics. In some implementations, the selection engine 144 can determine the relevance score for a user based at least in part on a topic of the request in view of the user's profile information. The selection engine 144 can then identify the user or group of users for providing input based on the relevance score (e.g., by selecting the user or users having the highest relevance score).

Once the reviewing user or group of users have been identified, the selection engine 144 supplies 208 the profile for the second user to each of the reviewing user(s) for review. The selection engine 144 also enables 210 network communication between the first user and the reviewing user or group of users to provide the input. For example, the selection engine 144 can enable a live chat, asynchronous messaging, or some other form of messaging between the first user and the reviewing users via the social networking platform (e.g., the social network application 122). In some implementations, the network communications can be one-way communications from, for example, the reviewing users to the requesting user.

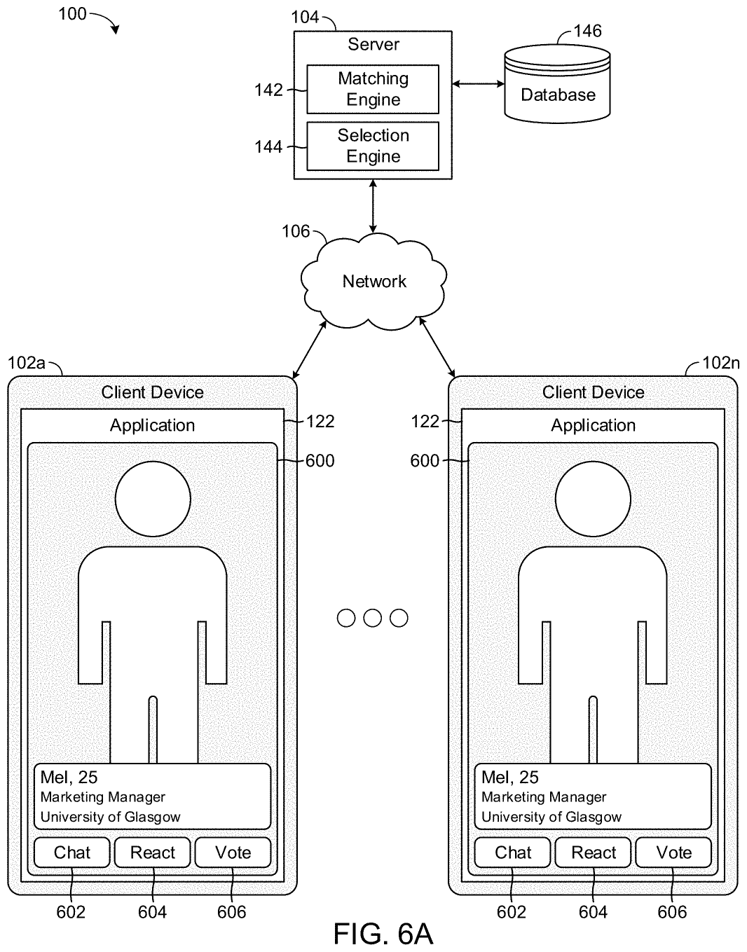

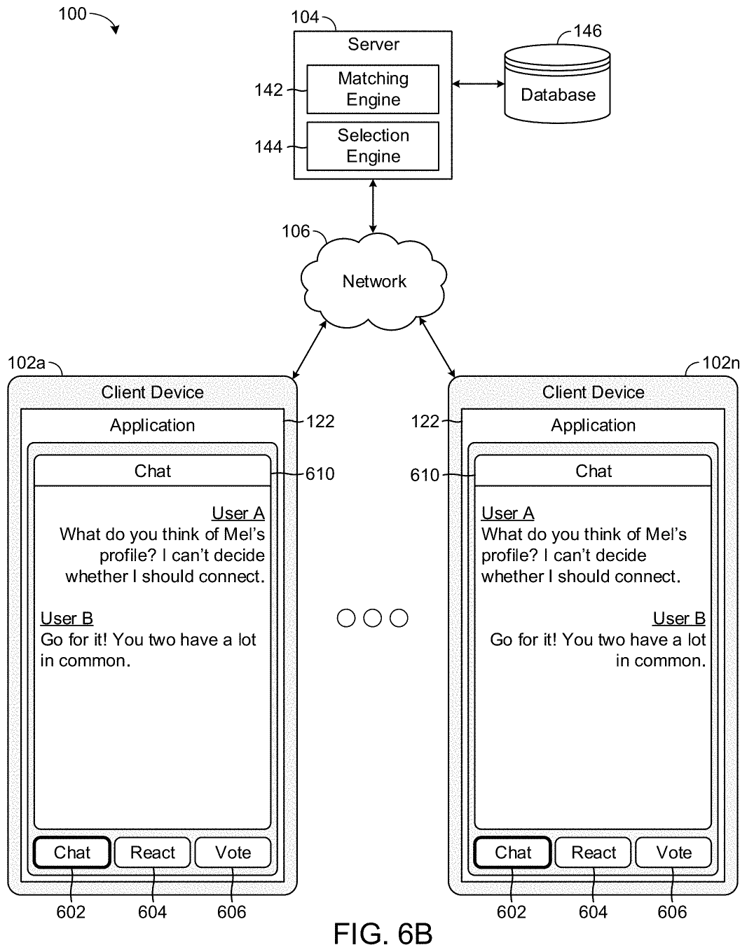

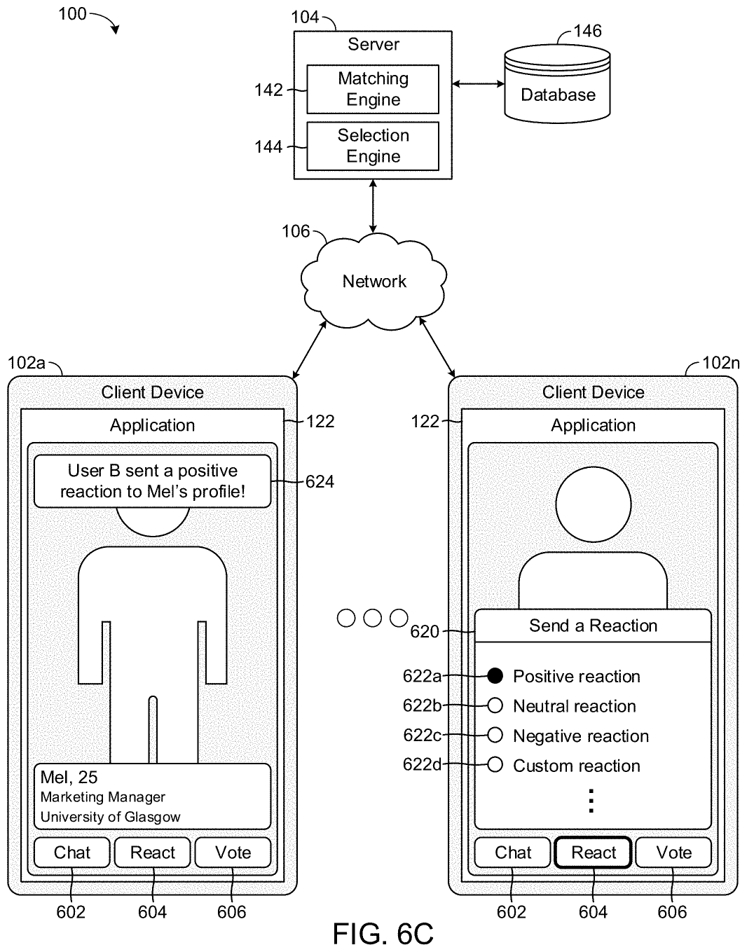

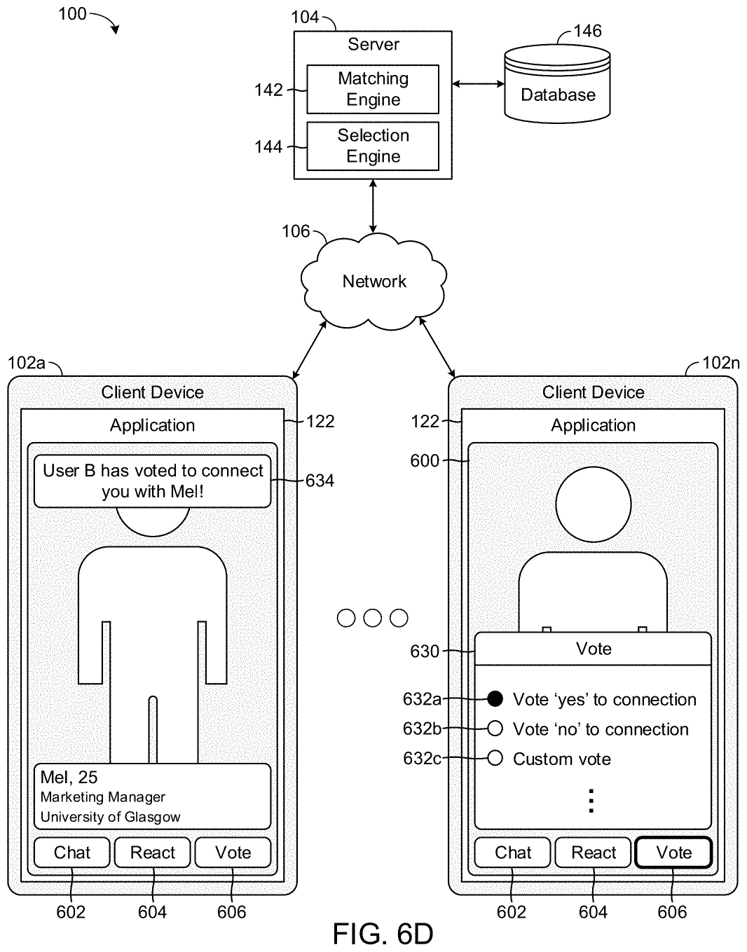

Upon receipt of the second user's profile, the applications 122 executing on the client devices 102 operated by each of the first user and the one or more reviewing users can display a user interface 600 that allows the each user to view and explore the information that has been added to the second user's profile, as shown in FIG. 6A. The user interface 600 also includes an option 602 to chat, an option 604 to react, and an option 606 to vote. Upon selection of the option 602 to chat, the application 122 displays a messaging system 610 that allows the first user and the one or more reviewing users share input regarding the potential match between the first user and the second user, as shown in FIG. 6B. In some implementations, the messaging system 610 is a live chat, asynchronous messaging system, or another messaging system and supports sharing of text, audio, image, and video messages between the first user and the one or more reviewing users.

Selection of the option 604 causes the application 122 to display a user interface 620 that allows a user to share a reaction with the first user and/or the one or more other users, as shown in FIG. 6C. For example, one of the reviewing users (or, in some implementations, the first user) can interact with the user interface 620 react to the second user's profile by selecting a predefined reaction 622a, 622b, or 622c, or by creating a custom reaction 622d, among others. An indication 624 of the selected reaction can be sent to the first user and/or the reviewing users for display by the application 122.

After reviewing the second user's profile, the one or more reviewing users (or, in some implementations, the first user) can select the option 606 to vote whether the first user should connect with the second user. Upon selection of the option 606, the application 122 displays a user interface 630 that allows a reviewing user to vote ‘yes’ to the connection 632a, vote ‘no’ to the connection 632b, or input a custom vote 632c. In some implementations, the vote is supplied by other means (e.g., by swiping left or right on the profile). In some implementations, an indication 634 of the vote is sent to the first user and/or the reviewing users for display by the application 122.

Referring back to FIG. 2, at 212, the matching engine 142 and/or the selection engine 144 receives one or more votes to connect (or not connect) the first user with the second user. In some implementations, a vote to connect is received from the client device 102 operated by the first user. For example, the first user can use the input from the one or more other users to determine whether to connect with the second user, and can cast their vote accordingly (e.g., by swiping left or right on the profile, by selecting the option 606 to vote and interacting with the user interface 630, etc.). In some implementations, the reviewing user or group of users can vote to connect the first user with the second user on behalf of the first user. For example, the first user can appoint (or let the system appoint) a reviewing user or group of users to act as a proxy for the first user, and the reviewing user or group of users can review potential matches and vote to connect (or not connect) the first user with the potential matches on behalf of the first user. As another example, the matching engine 142 can collect the votes from the reviewing user or group of users and can determine, based on the votes, whether to connect the first user with the second user. The matching engine 142 can use various voting schemes when determining whether to connect the first user with the second user, such as a majority voting scheme (e.g., >50% of the votes decides), a modified majority voting scheme (e.g., >50% of the votes from a certain group of users, such as users of a particular gender, decides), a leader voting scheme (e.g., a leader selected by the user or system decides), or combinations of them, among others. In some implementations, the first user and the reviewing user or group of users need not be online at the same time for the voting, reacting, or sharing of messages to take place.

The matching engine 142 determines whether to connect the first user with the second user based on the received vote. If the first user is determined to have voted ‘yes’ to a connection with the second user, the matching engine 142 can place the profile of the first user into the queue of profiles to be viewed by the second user. If both the first user and the second user mutually vote ‘yes’ upon each other's profile, a match is established between the two users. Once a match is established, the matching engine 142 can enable network communication between the first user and the second user (the “matched users”) and can supply a notification of the match to either or both of the matched users with a prompt to contact the other matched user (e.g., using the messaging system provided by the application 122). On the other hand, if the first user is determined to have voted ‘no’ to a connection with the second user, no further connection is established between the two users, and their profiles are not shown to each other again (or they may be shown again depending on changes within their profile, location, search parameters, or because of time elapsed).

Although the foregoing discussion of cooperative decision making is in the context of determining whether to connect a requesting user with a potential match, the techniques described here can be readily applied to other use cases without departing from the scope of the present disclosure. For example, in some implementations, a requesting user can use the application 122 to request input on a service, and the matching module 142 and/or selection engine 144 can identify and enable communications with a reviewing user or group of users for providing input on the service. In some implementations, a requesting user can use the application 122 to request input on a question, and the matching module 142 and/or selection engine 144 can identify and enable communications with a reviewing user or group of users for providing input on the question. In some implementations, a requesting user can use the application 122 to request a bid on a product for sale, and the matching module 142 and/or the selection engine 144 can identify and enable communications with a reviewing user or group of users for providing bid(s) on the product.

The approaches described here can be implemented at least in part using a computer storage product with a computer readable storage medium having computer code thereon for performing various computer-implemented operations. The media and computer code may be those specially designed and constructed for the purposes of the approaches described here, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, the approaches described here may be implemented using JAVA®, C++, or other programming language and development tools. In some examples, the approaches described here may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the approaches described here. Thus, the foregoing descriptions of specific embodiments are presented for purposes of illustration and description. They are not intended to be exhaustive or to limit the invention to the precise forms disclosed; obviously, many modifications and variations are possible in view of the above teachings. The embodiments were chosen and described in order to best explain the principles of the approaches described here and its practical applications, they thereby enable others skilled in the art to best utilize the approaches described here and various embodiments with various modifications as are suited to the particular use contemplated. Other implementations not specifically described here are also within the scope of the following claims.

What is claimed is

1. A computer-implemented method comprising:
identifying a potential match between a first individual and a second individual based on one or more interests of the first individual, wherein each of the first individual and the second individual are members of a social network;
receiving, from a first client device associated with the first individual, a request for input regarding the potential match with the second individual;
in response to the request:
identifying one or more other individuals for providing input to the first individual regarding the potential match with the second individual;
supplying, to the first client device associated with the first individual and one or more other client devices associated with the respective one or more other individuals, data for display in a graphical user interface of the respective client devices, the data including profile information for the second individual; and
enabling network communication between the first individual and the one or more other individuals for providing the input to the first individual regarding the potential match with the second individual; and
receiving, from the first client device or at least one of the one or more other client devices, a vote to connect the first individual with the second individual.

2. The method of claim 1, comprising:
in response to the vote to connect the first individual with the second individual, enabling network communication between the first individual and the second individual.

3. The method of claim 1, comprising:
in response to the vote to connect the first individual with the second individual, supplying, to a second client device associated with the second individual, data for display in a graphical user interface of the second client device, the data including profile information for the first individual.

4. The method of claim 3, comprising:
receiving, from the second client device, a vote to connect the second individual with the first individual; and
enabling network communication between the first individual and the second individual in response to the vote to connect the first individual with the second individual and the vote to connect the second individual with the first individual.

5. The method of claim 1, wherein each of the one or more other individuals are members of the social network.

6. The method of any of claim 1, wherein the request includes a specification of the one or more individuals for providing the input to the first individual regarding the potential match with the second individual.

7. The method of claim 1, wherein enabling network communication between the first individual and the one or more other individuals comprises enabling sharing of reactions by the one or other individuals to the potential match.

8. The method of claim 1, wherein identifying the one or more other individuals for providing the input to the first individual regarding the potential match with the second individual comprises randomly selecting the one or more individuals from a plurality of individuals, wherein each of the plurality of individuals is a member of the social network.

9. The method of claim 1, wherein identifying the one or more other individuals for providing the input to the first individual regarding the potential match with the second individual comprises:
accessing profile information for each of a plurality of individuals, wherein each of the plurality of individuals is a member of the social network;
determining a relevance score for each of the plurality of individuals based on the profile information and the requested input; and
selecting the one or more individuals for providing the input based on the relevance score.

10. The method of claim 1, wherein the vote to connect the first individual with the second individual is received from the at least one of the one or more other client devices on behalf of the first individual.

11. The method of claim 1, wherein the one or more other individuals include at least a third individual operating a third client device, a fourth individual operating a fourth client device, and a fifth individual operating a fifth client device, and wherein the vote to connect the first individual with the second individual is determined based on a vote from each of the third, fourth, and fifth individuals operating the respective third, fourth, and fifth client devices.

12. The method of claim 11, wherein the vote to connect the first individual with the second individual is determined based on a majority of the votes from the third, first, and fifth individuals.

13. The method of claim 11, wherein the vote to connect the first individual with the second individual is determined based on a majority of the votes from the third, first, and fifth individuals of a particular gender.

14. The method of claim 11, comprising:
selecting a leader from among the third, fourth, and fifth individuals; and
determining the vote to connect the first individual with the second individual based on the vote from the leader.

15. The method of claim 1, wherein at least one of the first client device or the one or more other client devices are offline when the vote to connect the first individual with the second individual is received.

16. The method of claim 1, wherein identifying the potential match between the first individual and the second individual comprises:
accessing profile information for each of a plurality of individuals, wherein each of the plurality of individuals are members of a social network;
comparing the profile information for each of the plurality of individuals with the one or more interests of the first individual; and
identifying the potential match between the first individual and the second individual based on the comparison.

17. A system comprising:
one or more processors; and
memory storing instructions which, when executed by the one or more processors, cause the one or more processors to perform operations comprising:
identifying a potential match between a first individual and a second individual based on one or more interests of the first individual, wherein each of the first individual and the second individual are members of a social network;
receiving, from a first client device associated with the first individual, a request for input regarding the potential match with the second individual;
in response to the request:
identifying one or more other individuals for providing input to the first individual regarding the potential match with the second individual;
supplying, to the first client device associated with the first individual and one or more other client devices associated with the respective one or more other individuals, data for display in a graphical user interface of the respective client devices, the data including profile information for the second individual; and
enabling network communication between the first individual and the one or more other individuals for providing the input to the first individual regarding the potential match with the second individual; and
receiving, from the first client device or at least one of the one or more other client devices, a vote to connect the first individual with the second individual.

18. A non-transitory computer-readable medium storing instructions which, when executed by one or more processors, cause the one or more processors to perform operations comprising:
identifying a potential match between a first individual and a second individual based on one or more interests of the first individual, wherein each of the first individual and the second individual are members of a social network;
receiving, from a first client device associated with the first individual, a request for input regarding the potential match with the second individual;
in response to the request:
identifying one or more other individuals for providing input to the first individual regarding the potential match with the second individual;
supplying, to the first client device associated with the first individual and one or more other client devices associated with the respective one or more other individuals, data for display in a graphical user interface of the respective client devices, the data including profile information for the second individual; and
enabling network communication between the first individual and the one or more other individuals for providing the input to the first individual regarding the potential match with the second individual; and
receiving, from the first client device or at least one of the one or more other client devices, a vote to connect the first individual with the second individual.
